(19) United States
(12) Patent Application Publication
(10) Pub. No.: US 2024/0202523 A1
(43) Pub. Date: Jun. 20, 2024

(54) OPTICAL TRANSMITTING-RECEIVING MODULE WITH NEURAL NETWORK

(71) Applicant: Universita' Degli Studi Di Trento, Trento (IT)

(72) Inventors: Lorenzo Pavesi, Trento (IT); Mattia Mancinelli, Trento (IT); Paolo Bettotti, Trento (IT)

(21) Appl. No.: 18/554,645

(22) PCT Filed: Apr. 28, 2022
(86) PCT No.: PCT/IT2022/050113

§ 371 Date: Oct. 10, 2023

(30) Foreign Application Priority Data
May 4, 2021 (IT) 102021000011357

(51) Int. Cl. G06N 3/08

(52) U.S. Cl. CPC G06N 3/08

(57) ABSTRACT

An optical transmitting-receiving module with neural network, including a power divider which distributes an input signal to be corrected and sends it in waveguides to an optical delay component which imparts time delays to copies of the optical signal; an optical control component that weights each delayed copy with an amplitude and a phase that are electrically adjusted during a training procedure; and a coupler which recombines the N signals and a non-linear node to which a complex sum is sent at the output of the coupler.

### CROSS REFERENCE TO RELATED APPLICATIONS

This application is a U.S. national stage filing of International Patent Application No. PCT/IT2022/050113 filed Apr. 28, 2022, which claims priority to Italian Patent Application No. 102021000011357 filed May 4, 2021, the contents of each application are hereby incorporated by reference in their entirety.

### BACKGROUND OF THE INVENTION

### 1) Field of the Invention

The present invention refers to an optical transmitting-receiving module comprising a neural network.

In particular, the invention relates to an optical neural network made of integrated photonics and based on one or more composite interferometers associated with non-linear optical elements; this neural network can be directly integrated into an optical transponder or used as a transparent stage in an optical transmission line.

### 2) Background Art

Document WO2019246605 describes an optical neural network which requires that the signal, before being processed, be converted from an optical signal to an electrical signal.

Document CN110505021 describes an optical and electronic composite neural network in which only linear processing of the optical signal is performed.

These known neural networks are unable to process the optical signal (real and imaginary part) in the same neural network.

### SUMMARY OF THE INVENTION

Object of the present invention is providing a neural network that allows processing the complete optical signal (real and imaginary part) by regenerating the signal through compensation, mitigating the dispersive effects and optical non-linearity of the transmission line, replacing and/or simplifying the task of digital microprocessors; this is achieved in the transmitter through a pre-distortion of the signal and in the receiver through the regeneration of the signal.

Another object is providing an entirely optical device which compensates for the linear and non-linear effects of the distortion induced by the optical fiber on the transmitted signal without requiring any intervention on the fiber link or on the way in which the electrical data are optically encoded, acting directly on the transmitted optical signal and recovering the optical signal using a photonic neural network.

The above and other objects and advantages of the invention, as will emerge from the following description, are achieved with an optical neural network integrated in an optical transmitting-receiving module, such as the one in the main claim, which comprises a power divider which divides the signal into an input to be corrected (possibly previously divided into the two polarizations) and sends it in N waveguides to an optical delay component that imparts desired time delays to the copies of the optical signal, an optical control component that weights with each copy delayed with an amplitude aᵢ and a phase Φᵢ which are regulated electrically and preferably independently of each other, during a training procedure, a coupler that recombines the N signals and a non-linear node to which the complex sum is sent out of the coupler. Preferred embodiments and non-trivial variations of the present invention are the subject matter of the dependent claims.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

### BRIEF DESCRIPTION OF THE DRAWINGS

The present invention will be better described by a preferred embodiment, provided by way of non-limiting example, with reference to the attached drawings, in which:

FIG. 1 shows a schematic view of an optical transmitting-receiving module comprising a neural network according to the invention;

FIGS. 2A-2C show examples of the activation function of an optical transmitting-receiving module comprising a neural network according to the invention;

FIGS. 3A-3B show examples of the transfer function of the nonlinear node of an optical transmitting-receiving module comprising a neural network according to the invention;

FIG. 4 shows a first embodiment of a circuit of an optical transmitting-receiving module comprising a neural network according to the invention; and

FIG. 5 shows a second embodiment of a circuit of an optical transmitting-receiving module comprising a neural network according to the invention.

### DETAILED DESCRIPTION OF PREFERRED EMBODIMENTS

With reference to the figures, the optical transmitting-receiving module 10 with neural network according to the invention is preferably made with an integrated optical circuit and comprises a 1×N power divider (splitter) 11 which distributes the input signal to be corrected and sends it in N waveguides with N optical delay components 12, for example comprising a spiral with thermal phase shifter, a ring resonator, an electro-optical modulator, or combinations thereof, which imparts on the optical signal copies the desired time delays; preferably, the time scale of the delays is of the same order of magnitude as the autocorrelation time of the signal.

The input signal is a non-pulsed, continuous, analog, pulsed or digital signal.

The optical transmitting-receiving module 10 according to the invention, preferably the integrated optical circuit, further comprises an optical control component 14 which weights wᵢ each delayed copy with an amplitude aᵢ and a phase Φᵢ which are electrically regulated and preferably independently of each other, during a training procedure in which both the amplitude aᵢ and the phase Φᵢ of the weights wᵢ are trained independently of each other, with the following limits: 0-1 for the amplitude aᵢ and 0-2π for the phase Φᵢ, according to the formula wᵢ=aᵢe^{iΦ}^{ᵢ}.

The optical signal is processed in a complex field, not treating separately its real and imaginary parts

Alternatively, active elements can be used to determine the weights, for example Optical Semiconductor Amplifiers (SOA), which, being able to act both as attenuator and as amplifier, can have an amplitude >1.

Once the training procedure is complete, the controls can be left unchanged during the normal operation of the optical transmitting-receiving module 10.

The optical transmitting-receiving module 10 with neural network according to the invention also includes a N×1 coupler 15 which recombines the N signals and a non-linear node 16 to which the complex sum is sent out of the coupler 15.

Phase information are set due to the weight wᵢ imposed on each of the N channels, which act as multiple Mach-Zehnder MZ interferometers on the temporally distributed versions of the input signal.

In a second embodiment of the invention, the optical transmitting-receiving module 10 with neural network of the invention comprises an N×M coupler which recombines the N input signals into M output signals and M non-linear nodes 16 to which the complex sums coming out of the coupler 15 are sent.

Therefore, this optical circuit can be considered as: 1) a feed-forward neural network with single layer and complex values, 2) a 1×N×1 or 1×N×M optical interferometer where the signals in the N waveguides are controlled in amplitude and phase, 3) the hybrid implementation of a recurrent network (without explicit loops) as it multiplies N delayed copies of the input signal and uses these copies to correct the distortions of the optical input signal. The invention allows working with passive circuits, since the device does not require optical amplification to function properly. On the other hand, optically active nodes can be used to regenerate the amplitude of the signal as it propagates through the neural network to overcome the limitations of a passive device and increase its performance by making it transparent or amplifying.

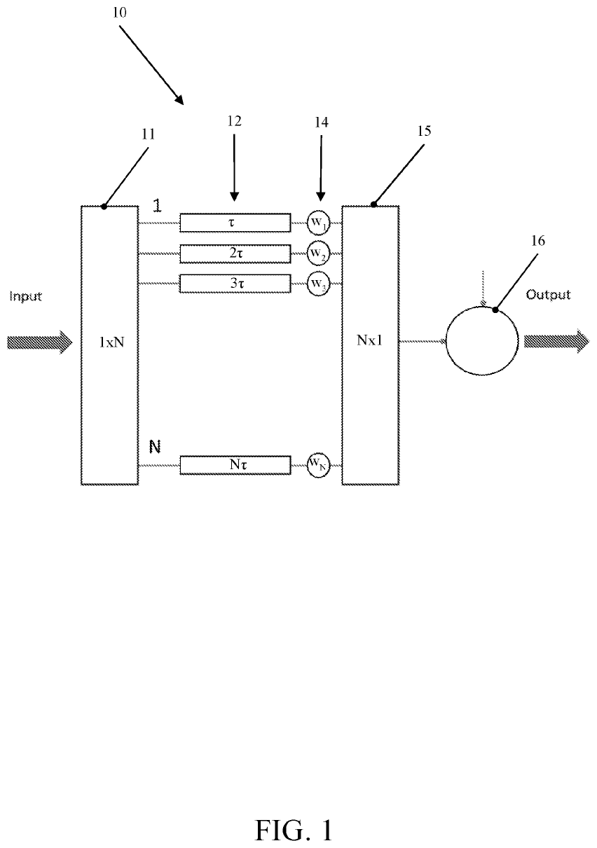

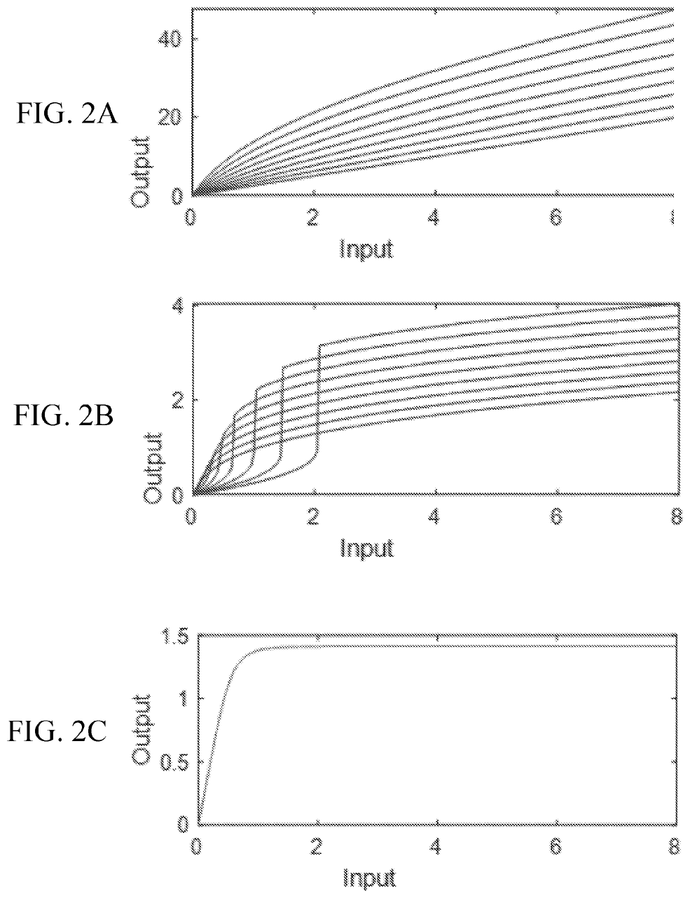

Preferably, the non-linear node 16 (see FIG. 1) can be an optical component (for example an optical semiconductor amplifier SOA, an optical semiconductor amplifier with a variable optical attenuator SOA+VOA, an amplifier with erbium-doped fiber, “Erbium Doped Waveguide Amplifier (EDWA)”, a bi-stable ring or micro-ring, a Mach-Zehnder MZ interferometer loaded with micro-ring, etc.) or an electrical component (for example a photodiode); FIGS. 2A-2C show examples of activation functions for a SOA optical semiconductor amplifier (different injection current, FIG. 2A), a bi-stable ring (different signal/wavelength of resonance detuning, FIG. 2B) and photodiode which works in saturation, FIG. 2C. An optimal solution for this type of non-linear node 16 is to use the sequence of a SOA semiconductor optical amplifier and a PIN photodiode in its non-linear region, namely near its saturation region, in case the neural network is the last stage of the communication line.

Alternatively, the optimal solution to keep the signal always optical involves the use of two branches, a first branch comprising a Mach-Zehnder MZ interferometer loaded with a semiconductor optical amplifier and a variable optical attenuator (SOA+VOA) and a second branch with a phase modulator. The optical nodes have activation functions that are tuned during the training phase: for example, the gain of the SOA semiconductor optical amplifier can be selected from the injection current, the bi-stability threshold of a micro-ring can be tuned by changing the difference between the wavelengths of the signal and the resonance of the micro-ring. If an SOA semiconductor optical amplifier is used, the entire device will be transparent to the optical signal (preferred solution), while if a photodiode is used, the signal is converted into electrical and it is the photodiode itself that applies the non-linear function. The signal correction is performed by fully optical passive elements with a single active node (such as an SOA semiconductor optical amplifier) introducing the required non-linearity. The neural network of the optical transmitting-receiving module 10 according to the invention is therefore able to perform a real-time mapping of the corrections to the input sequences, regardless of the modulation bit/symbol.

Advantageously, the use of a Mach-Zehnder MZ interferometer loaded with a semiconductor optical amplifier and a variable optical attenuator (SOA+VOA) allows the non-linear regions of the activation function to be used more effectively than using the SOA optical semiconductor amplifier only. Furthermore, this function is very similar to a sigmoid, a non-linear function that is widely used in machine learning, where it has proved to be one of the best. Another advantage is given by the possibility of modifying the shape of the function and the power beyond which the response becomes non-linear (threshold trend) by varying the injection current of the SOA optical semiconductor amplifier and the attenuation of the variable optical attenuator, VOA.

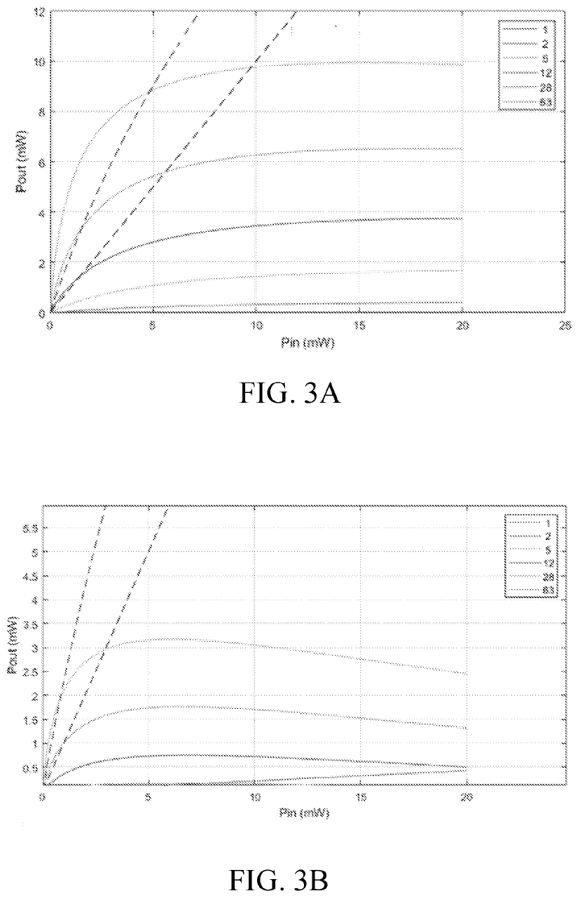

Examples of responses are shown in FIGS. 3A and 3B, where the response of the SOA semiconductor optical amplifier alone is compared with that of the Mach-Zehnder MZ interferometer loaded with a semiconductor optical amplifier and a variable optical attenuator (SOA+VOA) (0 dB, FIG. 3A and 3 dB, FIG. 3B).

The activation function of the non-linear node 16 can be electrically controlled during the training phase by an external control or by integrating the controller into the optical transmitting-receiving module 10 with the neural network according to the invention. A further embodiment of the non-linear node 16 is to use phase change materials [Wuttig, M., Bhaskaran, H. & Taubner, T. Phase-change materials for non-volatile photonic applications. Nature Photon 11, 465-476 (2017) https://doi.org/10.1038/nphoton.2017.126].

The training phase can be carried out during the testing of the newly produced optical transmitting-receiving module 10. In this case, the optical transmitting-receiving module is trained with different stress scenarios that identify its possible applications. For each scenario, a set of (current) weights are generated and stored in a look-up table. The end user can then select the scenario that is closest to the role of the optical transmitting-receiving module in the optical network.

Otherwise, the neural network training phase can be easily inserted into a real fiber optic network during the channel activation procedure. When a new channel is activated, an appropriate and known sequence (training sequence) is sent from the transmitter to the receiver, which will be used to tune the network to the performance of that specific link (in terms of dispersion, non-linearity, etc.).

The optical transmitting-receiving module 10 with neural network of the invention brings several innovations compared to other known techniques used to mitigate optical non-linearities, in particular the transmitting-receiving optical module according to the invention has the following advantages:
it is based on a simple neural network with few nodes and passive integrated photonic components (cheap, low power, small footprint and energy saving); preferably, the only active node is the non-linear node;
unlike other solutions, it has no recurrence and is a feed-forward network with physical nodes that analyze different instants of the signal (thanks to the delays induced by the spirals or delay lines);
the activation non-linear NL function is highly optimized and capable of being modulated, since it can choose the optimal non-linear NL function for the correction that the network must perform. Consequently, the neural network is able to modify its own behavior (following training) to maximize performance on different problems;
it performs the correction in real time of both linear dispersions and non-linear self-phase modulation, and does not require intensive electronic and/or computational resources to perform these corrections. The optical transmitting-receiving module of the invention relieves the computational efforts of the digital signaling processor (DSP) in coherent systems;
it was found through modeling/experimentation that the optical transmitting-receiving module 10 of the invention is able to correct the signal subject to strong dispersion in real time; since the neural network is trained using both amplitude and phase of the signal, it replaces the hardware system, currently used in coherent sensing, with a much simpler, entirely optical (and near passive) neural 20 network, i.e. the invention does not require the use of local oscillators that can be removed in differential coded protocols;
the fact that both amplitude and phase can be used to train the neural network allows for the implementation of two independent neural networks, one trained using signal amplitude and the other using signal phase; thus, both parameters will be (independently) corrected and recovered, allowing the demodulation of complex modulation formats (such as QPSK and m-QAM with differential encoding);
the optical transmitting-receiving module of the invention is all optical, based on machine learning, can be trained on different training sets, is not based on a specific signal coding, can be integrated in the same form-factor of existing transceiver devices, it is energy saving compared to similar solutions based on digital signal processor (DSP), and can be produced using cost-effective and large-volume CMOS photonics;
the integration of the neural network in the transceiver both on the TX transmission line and on the RX reception line allows both pre-dispersion/pre-conditioning and/or recovery of the non-linear distortion of the optical signal; in this way, it creates a neural network of the auto-encoder type;
when an entirely optical activation function is used, the neural network always maintains the signals in the optical domain: therefore, the optical transmitting-receiving module of the invention can also be inserted as a signal reconditioning stage before the inline amplifier in a pre-existing optical link, for example long range.

Advantageously, the neural network can recover the distorted signal directly in the analog domain. The training of the network is performed by minimizing the standard deviation or the Bit Error Rate (BER) between the undistorted signal and the correct signal, by acting on the weights and on the selection of the activation functions. The standard deviation is minimized by means of a minimization algorithm (genetic algorithm, or others).

This neural network can be integrated on a perspective. In platform in an integrated particular, usable platforms are:
1. Indium phosphide (InP)
2. Silicon on Oxide (SOI)
3. Silicon Nitride (SiN)
4. Si+III-V, SiN+III-V hybrid platforms based on silicon Si or silicon nitride SiN with elements of groups III and V
5. other platforms for integrated optics (glass, plastic, organic, . . . ).

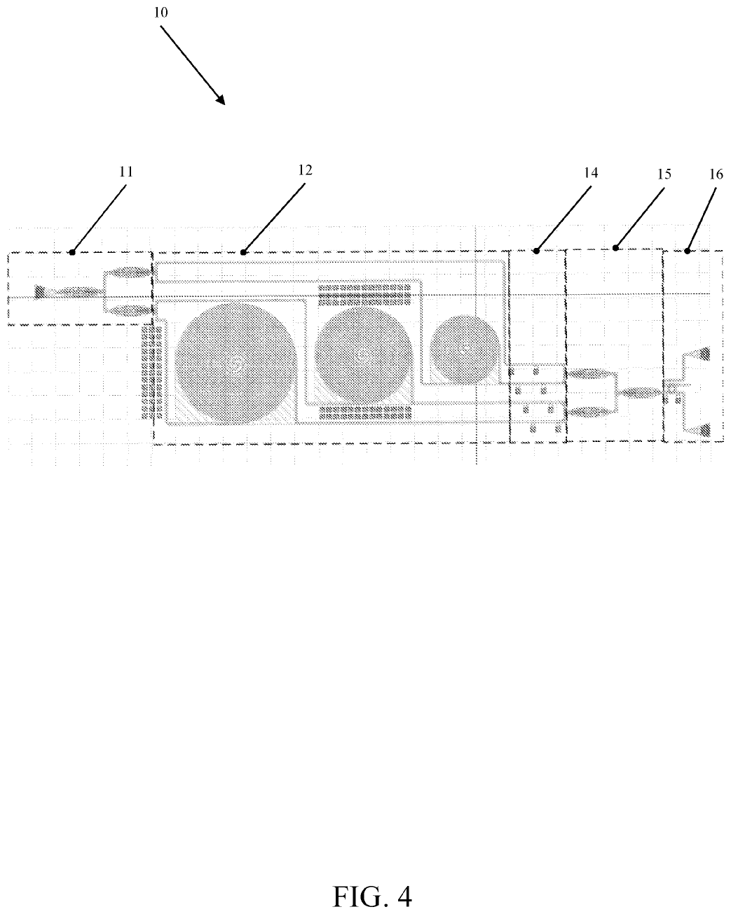

An example of a circuit that realizes the neural network with N=4 in platform is shown in FIG. 4.

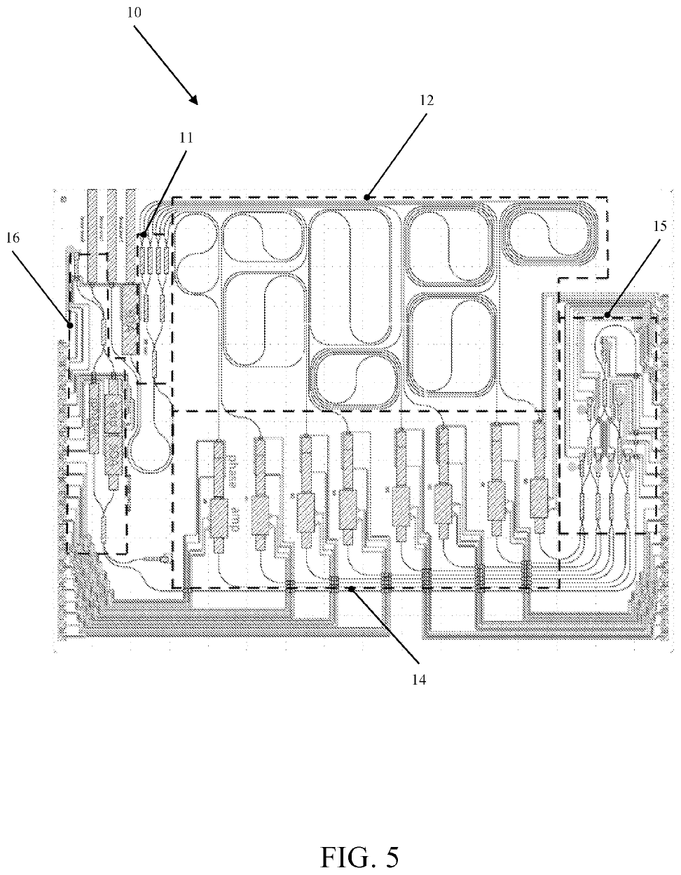

An example of a circuit that realizes the neural network in the InP platform is shown in FIG. 5.

1. An optical transmitting-receiving module with neural network, comprising:
a power divider which distributes an input signal to be corrected and sends it in N waveguides to an optical delay component which imparts time delays to copies of the optical signal,
an optical control component that weights each delayed copy with an amplitude and a phase that are electrically adjusted during a training procedure, where the optical signal is processed in a complex field, not treating separately its real and imaginary parts, and
a coupler which recombines the signals and a non-linear node to which a complex sum is sent at the output of the coupler,
wherein the input signal is a non-pulsed, continuous, analog, pulsed or digital signal.

2. The optical transmitting-receiving module of claim 1, wherein the optical delay component comprises a coil with a thermal phase shifter and/or a ring resonator and/or an electro-optical modulator.

3. The optical transmitting-receiving module of claim 1, wherein, in the training procedure, both amplitude aᵢ and phase Φᵢ of the weights wᵢ are trained independently of each other, with the following limits: 0-1 for amplitude aᵢ and 0-2π for phase Φᵢ according to the formula wᵢ=aᵢ, or, alternatively, active elements are used to determine the weights which, being able to act as both attenuator and amplifier, can have amplitude >1.

4. The optical transmitting-receiving module of claim 1, wherein phase information are set due to the weight imposed on each of the N channels, which act as multiple Mach-Zehnder MZ interferometers on temporally distributed versions of the signal at input.

5. The optical transmitting-receiving module of claim 1, wherein the non-linear node is an optical component or an electrical component.

6. The optical transmitting-receiving module of claim 5, wherein the optical component is a semiconductor optical amplifier, a semiconductor optical amplifier with a variable optical attenuator, a Erbium-doped fiber amplifier, a bi-stable ring or micro-ring, a Mach-Zehnder MZ interferometer loaded with micro-ring.

7. The optical transmitting-receiving module of claim 5, wherein the electrical component is a photodiode used in a non-linear region.

8. The optical transmitting-receiving module of claim 5, wherein the non-linear node comprises the sequence of an optical semiconductor amplifier and a photodiode close to its region of saturation in case the neural network is a last stage of a communication line.

9. The optical transmitting-receiving module of claim 5, wherein the non-linear node comprises two branches in a sequence, a first branch comprising a Mach-Zehnder interferometer with a semiconductor optical amplifier and a variable optical attenuator and a second branch with a phase modulator, the first and second branches being part of the same nonlinear node having a single input and a single output, the first and second branches being connected inside the nonlinear node to provide a single output.

10. The optical transmitting-receiving module of claim 1, wherein the optical nodes have activation functions which are tuned during the training phase.
